(19) United States
(12) Patent Application Publication
(10) Pub. No.: US 2026/0219059 A1
(43) Pub. Date: Jul. 30, 2026

(54) SYSTEM AND METHOD FOR GENERATING A BIRD'S EYE VIEW MAP

(71) Applicant: GM GLOBAL TECHNOLOGY OPERATIONS LLC, Detroit, MI (US)

(72) Inventors: Shuqing Zeng, Sterling Heights, MI (US); Fan Bai, Ann Arbor, MI (US); Liangjun Zhang, Cupertino, CA (US); Cem U. Saraydar, Birmingham, MI (US)

(73) Assignee: GM GLOBAL TECHNOLOGY OPERATIONS LLC, Detroit, MI (US)

(21) Appl. No.: 19/041,640

(22) Filed: Jan. 30, 2025

(51) Int. Cl. G01C 21/36; B60W 50/14; G06T 7/70

(52) U.S. Cl. CPC G01C 21/3635; B60W 50/14; G06T 7/70; B60W 2050/146

(57) ABSTRACT

A geo-hashed BEVM is advantageously created employing crowd-sourced monocular images in coordination with an existing electronic map, e.g., Open Street Map (OSM) in one embodiment. The electronic representation of the bird's eye view map (BEVM) may be leveraged to produce an extended lane semantics output, and thus an on-vehicle electronic map may be dynamically updated to account for present circumstances, whether permanent, semi-permanent, or temporal.

### INTRODUCTION

Electronic mapping systems for on-vehicle navigation and intelligent highway systems may reside on-vehicle, a cloud, or in a remote office environment. Electronic mapping systems may lack freshness due to temporal changes such as localized construction activities. Lack of freshness in an electronic mapping system may affect operation of a vehicle having an advanced driver assistance system (ADAS).

### SUMMARY

There are benefits to having a precise, accurate and up-to-date electronic map of vehicle travel lanes, including for purposes of operation of on-vehicle control systems that provide driving automation, e.g., an advanced driver assistance system (ADAS), and for purposes of operation of intelligent highway systems.

The concepts described herein provide a system, method, and/or apparatus that generate an electronic representation of a bird's eye view map (BEVM) that is geo-hashable. The geo-hashed BEVM is advantageously created employing crowd-sourced monocular images in coordination with an existing electronic map, e.g., Open Street Map (OSM) in one embodiment. The electronic representation of the BEVM may be leveraged to produce an extended lane semantics output, and thus an on-vehicle electronic map may be dynamically updated to account for present circumstances, whether permanent, semi-permanent, or temporal.

The concepts described herein provide a system, method, and/or apparatus that generate an up-to-date electronic map of an area for use by one or more vehicles, which may be employed in operation and/or control of those vehicles, including operation of an on-vehicle control system that is capable of providing a level of driving automation, e.g., an advanced driver assistance system (ADAS).

An aspect of the disclosure may include a system and associated method for generating a localized high-definition digital street map that is representative of a geographical area. This includes a controller that is in communication with a plurality of vehicles in a pre-defined geographic region, wherein the plurality of vehicles have forward-looking digital cameras and GNSS (Global Navigation Satellite System) sensors. The controller has access to a memory device containing executable code that includes a BEV mapping routine, wherein the BEV mapping routine includes as follows. The BEV mapping routine captures, for a geographical area, a plurality of images and a plurality of corresponding locations via the plurality of vehicles having digital cameras and GNSS sensors. The BEV mapping routine extracts a plurality of anchor points from the plurality of images, determines a three-dimensional (3D) pose of each of the plurality of images, and refines alignment of each of the plurality of images. The BEV mapping routine aggregates and encodes the 3D pose of each of the plurality of images into an open street map (OSM) to generate a global BEV map (BEVM) portion for the geographical area. The BEV mapping routine then decodes a header of the BEVM portion to extract features for the geographical area.

Another aspect of the disclosure may include the BEV mapping routine having the following actions: accessing, via one of the plurality of vehicles, the customized BEVM portion from the memory device; and decoding the customized BEVM portion to extract features for the geographical area.

Another aspect of the disclosure may include the one of the plurality of vehicles including a navigation system and an advanced driver assistance system (ADAS); wherein the one of the plurality of vehicles operates the ADAS system based upon the features for the geographical area.

Another aspect of the disclosure may include the BEV mapping routine further having the following actions: communicating the customized BEVM portion to one of the plurality of vehicles to effect operational control thereof.

Another aspect of the disclosure may include executing a neural network to aggregate and encode the 3D pose of each of the plurality of images into the electronic map to generate the customized BEVM portion for the geographical area.

Another aspect of the disclosure may include the plurality of vehicles having digital cameras and GNSS sensors that are geo-fenced based upon proximity to the geographical area.

Another aspect of the disclosure may include the electronic map being based upon an open street map.

Another aspect of the disclosure may include the pose of each of the plurality of images being a three-dimensional (3D) pose.

Another aspect of the disclosure may include the plurality of images that are captured being two-dimensional (2D) images that are forward of the vehicle.

Another aspect of the disclosure may include the memory device being cloud-based.

Another aspect of the disclosure may include a method for generating a digital street map that is representative of a geographical area. The method includes capturing, via a controller, a plurality of images and a plurality of corresponding locations for a geographical area via a plurality of vehicles having digital cameras and Global Navigation Satellite System (GNSS) sensors; extracting a plurality of anchor points from the plurality of images; estimating a pose of each of the plurality of images based upon the plurality of anchor points from the plurality of images; aggregating and encoding, via a bird's eye view (BEV) mapping routine, the pose of each of the plurality of images into an electronic map; generating a customized BEVM portion for the geographical area based upon the electronic map; and storing the customized BEVM portion in the memory device.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a remote office that is capable of wirelessly communicating with a plurality of vehicles via a communication system, and a cloud environment, in accordance with the disclosure.

FIG. 2 schematically illustrates an overview of a system for generating an embodiment of a customized bird's eye view map (BEVM), in accordance with the disclosure.

FIG. 3 schematically illustrates details related to an embodiment of a map construction routine to generate an electronic representation of a customized BEVM, in accordance with the disclosure.

FIG. 4 schematically illustrates a first image processing step including a process for backend anchor point cloud construction, in accordance with the disclosure.

FIG. 5 schematically illustrates a second image processing step, in accordance with the disclosure.

FIG. 6 schematically illustrates elements for aggregating and encoding information to form a global BEVM employing a deformable spatial cross attention (DSCA) routine, in accordance with the disclosure.

FIG. 7 schematically illustrates elements for decoding and up-to-date BEV map, thus enabling it to be useable as an element of an on-vehicle or off-vehicle navigation system, in accordance with the disclosure.

FIG. 8 schematically illustrates details related to another embodiment of a map construction routine to generate an electronic representation of a customized BEV map, in accordance with the disclosure.

The appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments can be practiced without some of these details. Moreover, for the purpose of clarity, certain technical material that is understood in the related art has not been described in detail to avoid unnecessarily obscuring the disclosure. Furthermore, the disclosure, as illustrated and described herein, may be practiced in the absence of an element that is not specifically disclosed herein. Directional terms such as top, bottom, left, right, up, over, above, below, beneath, rear, front, horizontal, and vertical are non-limiting descriptive terms that may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description is merely illustrative in nature and is not intended to limit the application and uses. Furthermore, there is no intention to be bound by an expressed or implied theory presented herein.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

The use of ordinals such as first, second and third does not necessarily imply a ranked sense of order, but rather may distinguish between multiple instances of an act or structure.

The numerical values of parameters (e.g., of quantities or conditions) in this specification, including the appended claims, are to be understood as being modified by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters.

When an element is “fixed on” or “disposed on” another element, the element may be attached to another element directly or by using an intermediate element. When an element is considered as “connected to” or “coupled to” another element, the element may be connected to the other element directly or by using an intermediate element.

Unless otherwise defined, technical and scientific terms used herein have the same meanings as commonly understood by those skilled in the art to which the present disclosure pertains. The terms used herein are intended for describing specific implementations, and not limiting. As used in this specification, the term “and/or” includes combinations of one or more associated listed items.

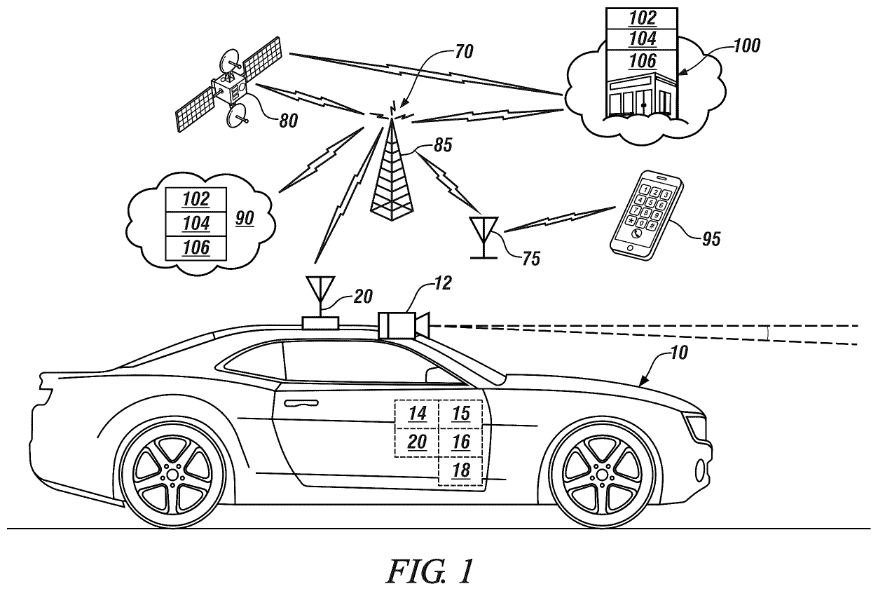

Referring to the drawings, wherein like reference numerals correspond to like or similar components throughout the several Figures, FIG. 1, consistent with embodiments disclosed herein, schematically illustrates a remote office 100 that is capable of wirelessly communicating with a plurality of vehicles 10 (one shown) via a communication system 70, including in a cloud environment 90.

The remote office 100 includes one or a plurality of controllers 102 that are arranged to execute one or a plurality of algorithms 104 employing information that is stored in one or a plurality of memory storage devices 106. At least a portion of the plurality of controllers 102, the plurality of algorithms 104 and the plurality of memory storage devices 106 may be arranged in the cloud environment 90.

The communication system 70 provides a communication network, which may be in the form of a satellite 80, a cell tower antenna 85, a dedicated short-range communication link 75, a cell phone 95, and/or another mode of communication, which are configured to effect communication with the plurality of vehicles 10.

The plurality of vehicles 10 may include, in one embodiment, a four-wheel passenger vehicle with steerable front wheels and fixed rear wheels. The vehicle 10 may include, by way of non-limiting examples, a passenger vehicle, a light-duty or heavy-duty truck, a utility vehicle, an agricultural vehicle, an industrial/warehouse vehicle, or a recreational off-road vehicle.

Each of the plurality of vehicles 10 includes a spatial monitoring system 12 and associated controller, a GNSS (Global Navigation Satellite System) sensor 14, a navigation system 16, a telematics system 18, and an antenna 20, which are in communication with and operationally controlled via one or a plurality of controllers 15. In one embodiment, one or more of the vehicles 10 includes an autonomic vehicle control system 25.

The vehicle spatial monitoring system 12 includes one or a plurality of spatial sensors that is arranged to monitor field(s) of view proximal to the vehicle 10 and generate digital representations of the fields of view including proximate remote objects. The spatial sensor(s) is located at one or multiple locations on the vehicle 10, and include a front camera capable of viewing a forward field of view (FOV) in one embodiment. Alternatively, or in addition, the spatial monitoring system may include a rear camera capable of viewing a rearward FOV, a left camera capable of viewing a leftward FOV, and/or a right camera capable of viewing a rightward FOV. The front camera is arranged to capture and pixelate 2D images of the forward FOV. The front camera may utilize a fish-eye lens to maximize its reach of the respective FOVs. Alternatively, the spatial sensor may further include a radar sensor and/or a LiDAR device, although the disclosure is not so limited. Placement of the spatial sensor(s) permits the spatial monitoring system 12 to monitor traffic flow including proximate vehicles, other objects around the vehicle 10, and the ground surface. The spatial sensor(s) may further include object-locating sensing devices including range sensors, such as FM-CW (Frequency Modulated Continuous Wave) radars, pulse and FSK (Frequency Shift Keying) radars, and Lidar (Light Detection and Ranging) devices, and ultrasonic devices which rely upon effects such as Doppler-effect measurements to locate forward objects. The possible object-locating devices include charged-coupled devices (CCD) or complementary metal oxide semi-conductor (CMOS) video image sensors, and other camera/video image processors which utilize digital photographic methods to ‘view’ forward objects including one or more proximal vehicle(s). Such sensing systems are employed for detecting and locating objects in automotive applications and are useable with systems including, e.g., adaptive cruise control, autonomous braking, autonomous steering and side-object detection.

The autonomic vehicle control system 25 includes an on-vehicle control system that can provide a level of driving automation, e.g., an advanced driver assistance system (ADAS). The terms ‘driver’ and ‘operator’ describe the person responsible for directing operation of the vehicle, whether actively involved in controlling one or more vehicle functions or directing autonomous vehicle operation. Driving automation can include a range of dynamic driving and vehicle operation. Driving automation can include some level of automatic control or intervention related to a single vehicle function, such as steering, acceleration, and/or braking, with the driver continuously having overall control of the vehicle. Driving automation can include some level of automatic control or intervention related to simultaneous control of multiple vehicle functions, such as steering, acceleration, and/or braking, with the driver continuously having overall control of the vehicle. Driving automation can include simultaneous automatic control of the vehicle driving functions, including steering, acceleration, and braking, wherein the driver cedes control of the vehicle for a period during a trip. Driving automation can include simultaneous automatic control of vehicle driving functions, including steering, acceleration, and braking, wherein the driver cedes control of the vehicle for an entire trip. Driving automation includes hardware and controllers configured to monitor a spatial environment under various driving modes to perform various driving tasks during dynamic operation. Driving automation can include, by way of non-limiting examples, cruise control, adaptive cruise control, lane-change warning, intervention and control, automatic parking, acceleration, braking, and the like.

The vehicle systems, subsystems and controllers associated with the autonomic vehicle control system 25 are implemented to execute one or a plurality of operations associated with the autonomous vehicle functions, including, by way of non-limiting examples, an adaptive cruise control (ACC) operation, lane guidance and lane keeping operation, lane change operation, steering assist operation, object avoidance operation, parking assistance operation, vehicle braking operation, vehicle speed and acceleration operation, vehicle lateral motion operation, e.g., as part of the lane guidance, lane keeping and lane change operations, etc. The vehicle systems and associated controllers of the autonomic vehicle control system 25 can include, by way of non-limiting examples, a drivetrain, a steering system, a braking system, and/or a chassis system. Each of the vehicle systems and associated controllers may further include one or more subsystems and one or more associated controllers. It should be appreciated that the functions described and performed by the discrete elements may be executed using one or more devices that may include algorithmic code, calibrations, hardware, application-specific integrated circuitry (ASIC), and/or off-board or cloud-based computing systems.

The term “controller” and related terms such as control module, module, control, control unit, processor and similar terms refer to one or various combinations of Application Specific Integrated Circuit(s) (ASIC), electronic circuit(s), central processing unit(s), e.g., microprocessor(s) and associated non-transitory memory component(s) in the form of memory and storage devices (read only, programmable read only, random access, hard drive, etc.). The non-transitory memory component can store machine-readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. The term ‘model’ refers to a processor-based or processor-executable code and associated calibration that simulates a physical existence of a device or a physical process. The terms ‘dynamic’ and ‘dynamically’ describe actions, steps or processes that are executed in real-time and are characterized by monitoring or otherwise determining states of parameters and regularly or periodically updating the states of the parameters during execution of a routine or between iterations of execution of the routine. The terms “calibration”, “calibrate”, and related terms refer to a result or a process that compares an actual or standard measurement associated with a device with a perceived or observed measurement or a commanded position. A calibration as described herein can be reduced to a storable parametric table, a plurality of executable equations or another suitable form. Communication between controllers, and communication between controllers, actuators and/or sensors may be accomplished using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that can travel through a medium. A parameter is defined as a measurable quantity that represents a physical property of a device or other element that is discernible using one or more sensors and/or a physical model. A parameter can have a discrete value, e.g., either “1” or “0”, or can be infinitely variable in value.

Elements may be implemented in the cloud environment 90. In this description and the following claims, the cloud environment 90 includes a shared pool of configurable computing resources (e.g., networks, servers, storage, applications, and services) that can be rapidly provisioned via virtualization and released with minimal management effort or service provider interaction, and then scaled accordingly. The cloud environment 90 can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

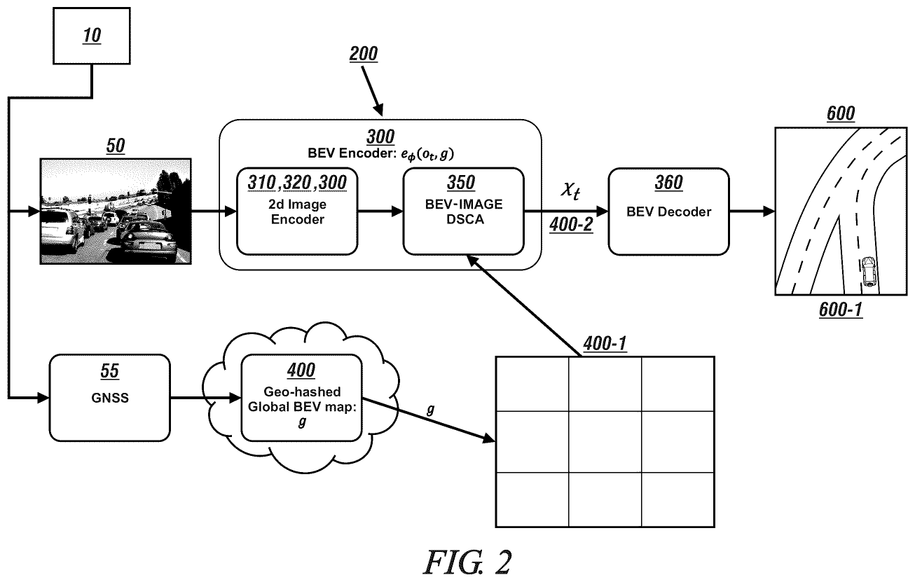

FIG. 2 schematically illustrates an overview of a system 200 for generating an embodiment of a customized bird's eye view map (BEVM) 600, which is an up-to-date, crowd-sourced geo-hashed BEVM. The cameras from the plurality of vehicles 10 generate a plurality of images 50 and corresponding GNSS locations 55, which are continuously, periodically, and/or regularly input to the system 200. The plurality of images 50 are input to a map construction routine 300, and the corresponding GNSS locations 55 are input to a geo-hashed global BEVM 400. The map construction routine 300 includes a two-dimensional (2D) image encoder, including a neural network and alignment routine 310, an aggregation routine 320, and an encoding routine 330, which act on the plurality of images 50 to generate an encoded image 335, i.e., e (Ot, g). The geo-hashed global BEVM 400 identifies a corresponding original BEV tile portion 400-1. The encoded image 335 and BEV tile portion 400-1 are input to a deformable spatial cross attention (DSCA) routine 350, which generates the updated BEV tile portion 400-2, which is incorporated into the customized BEVM 600. The customized BEVM 600, including updated BEV tile portion 400-2, may be stored on-vehicle and/or in the cloud environment.

Deformable spatial cross attention (DSCA) refers to a type of attention mechanism used in deep learning, particularly in transformer architectures, where the attention process is not limited to fixed spatial locations but can dynamically adjust its focus by learning offsets to deform the attention window, allowing it to attend to relevant features across different spatial locations within an image or other data modality, especially when comparing features between two different input sources (cross-attention) based on their spatial context. Key points about deformable spatial cross attention include a dynamic attention focus, wherein the deformable attention can learn to shift its focus by calculating additional offset values, allowing it to attend to more relevant areas within an image, even if they are not aligned with the original grid. Cross-modal capability includes cross-attention, wherein deformable attention can effectively compare features between different data sources, such as comparing features from an image to text descriptions, by adaptively focusing on relevant spatial regions in each modality. The concept of deformable attention draws inspiration from deformable convolution, which allows for flexible spatial sampling by learning offsets to adapt the convolution kernel to the local image structure.

Subsequently, the BEVM 600, including updated BEV tile portion 400-2 may be subsequently input to a BEV decoder 360 to provide a localized portion 600-1 of the customized BEVM 600, which may be used on-vehicle to provide information to a driver, and/or to operate an element of the ADAS system.

The system 200 enables leveraging road-related information from a previous trip or crowdsourcing to compensate for a localized occlusion in the BEV map, and is insensitive to misalignment between the global BEVM due to GNSS noise.

The concepts described herein provide for generating an electronic representation of the customized BEVM 600. The customized BEVM 600 may be cloud-based, remote office-based, and/or on-vehicle-based. The customized BEVM 600 is advantageously created employing crowd-sourced monocular images in coordination with an existing electronic map, e.g., an Open Street Map (OSM) in one embodiment. The electronic representation of the BEVM may be leveraged to produce an extended lane semantics output, and thus an on-vehicle electronic map may be dynamically updated to account for present circumstances, whether permanent, semi-permanent, or temporal. OSM is a collaborative, open-source project where volunteers from around the world contribute to create a free, editable map of the Earth, allowing anyone to access and modify geographical data like roads, buildings, and points of interest through a web interface. OSM semantics refers to the system of tags and attributes used to describe geographic features on the OSM map, essentially providing meaning and context to the map data by defining what a particular point, line, or area represents through a set of key-value pairs called tags, thus permitting users to categorize and detail features like roads, buildings, businesses, and natural elements on the map, making the data more interpretable for machines and humans alike.

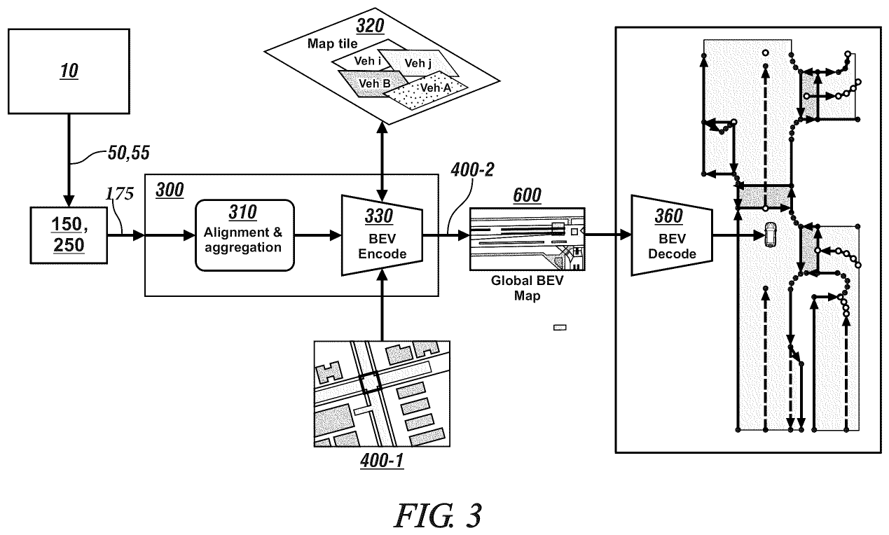

FIG. 3 schematically illustrates details related to an embodiment of the map construction routine 300 to generate an electronic representation of the customized BEVM 600, which involves crowd-sensing alignment, explicit 3D point cloud modeling, and OSM bootstrapping.

Overall, the map construction routine 300 includes taking input of raw images and GPS poses from each vehicle, with sparseness and compressed information being in a BEV representation. Along with the BEV representation, anchor points are extracted for alignment, with the alignment being simultaneously refined among map tiles from different sources. This facilitates building a globally consistent and accurate BEVM with anchor points that are derived from alignment and aggregation.

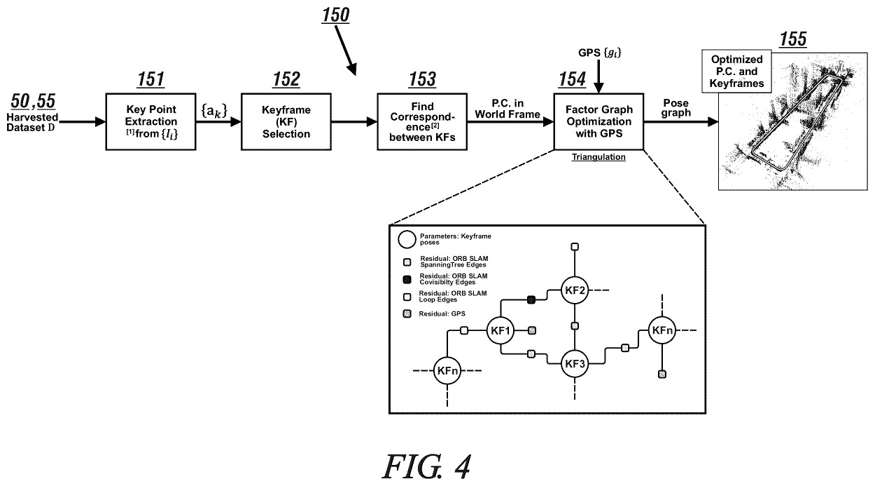

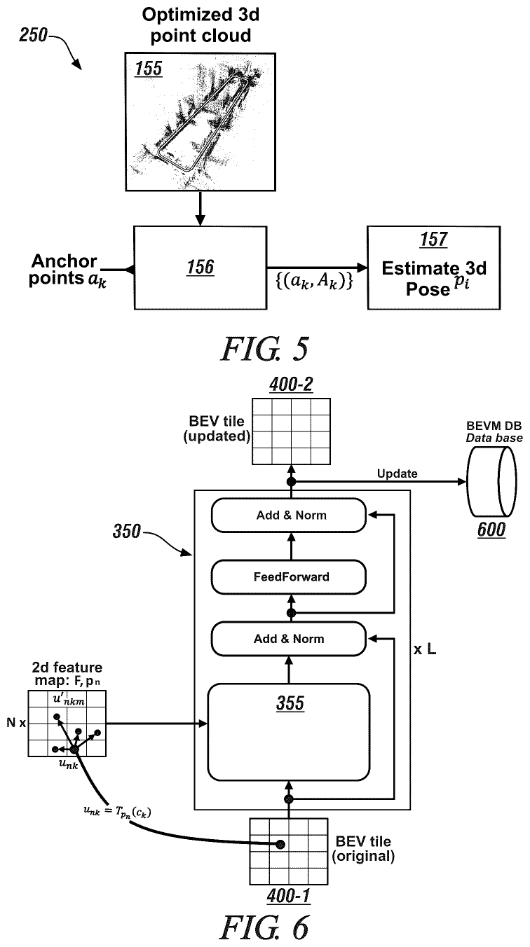

The cameras from the plurality of vehicles 10 generate a plurality of images 50 and corresponding GNSS locations 55, which are continuously, periodically, regularly and/or sporadically input to first and second image processing steps 150, 250, respectively. The first image processing step 150 is described with reference to FIG. 4, and the second image processing step 250 is described with reference to FIG. 5.

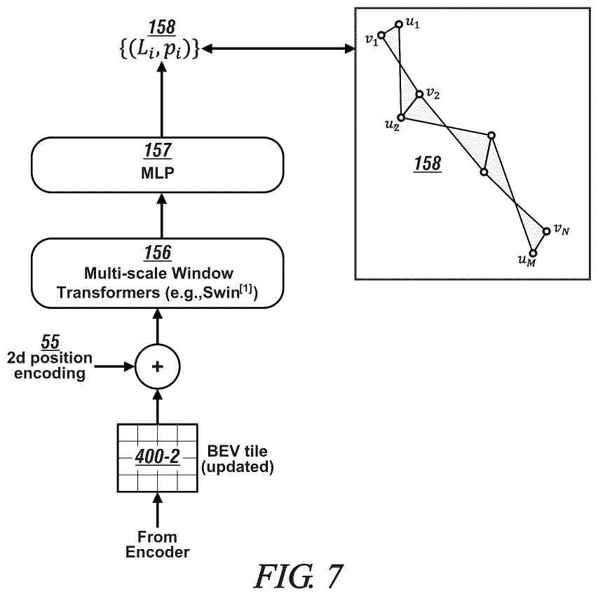

The output 175 of the first and second image processing steps 150, 250 is input to the map construction routine 300. The map construction routine 300 includes the alignment routine 310, the aggregation routine 320, and the encoding routine 330, which act on the output 175 employing a relevant original tile portion 400-1 of the geo-hashed BEVM 400 to generate an updated tile portion 400-2 for the customized BEVM 600. The updated tile portion 400-2 and the customized BEVM 600 are storable in the cloud environment 90 or memory device 106. The customized BEVM 600 is subjected to BEVM decoding 360, as described herein with reference to FIG. 7.

The first image processing step 150 is described with reference to FIG. 4, and includes a process for backend anchor point cloud construction. The harvested dataset, i.e., the plurality of images 50 and corresponding GNSS locations 55, are subjected to a key point extraction (from {li}) (151), which undergoes a keyframe (KF) selection (152). The keyframe selection logic includes choosing a subset of the harvested images so that any two keyframes within the subset maintain a minimal distance from each other, wherein the keyframe is vehicle- and image-specific. Correspondence between keyframes, if any, is found (153). At this point, the corresponding GNSS locations 55 are input to factor graph optimization with the GNSS location to obtain a pose graph via triangulation (154). The resultant 155 is shown as an image, and is an optimized 3D point cloud with keyframes.

The second image processing step 250 is described with reference to FIG. 5, and employs the resultant 155 in the form of the optimized 3D point cloud with keyframes. Overall, the second image processing step 250 includes estimating the 3D pose pᵢ of image Iᵢ for each item in the dataset D (157). This includes extracting the 2D key points from image Iᵢ (155), finding the key anchor points {aₖ}'s correspondence {Aₖ} in the optimized 3D point cloud (156), and optimizing the 3D pose p*ᵢ to minimize reprojection error of 3D points according to the following relationship:

$${p}_{i}^{*} = arg {min}_{{p}_{i}} \sum ‖ f ( {A}_{k} , {p}_{i} ) - {a}_{k} ‖ ,$$

wherein f(Aₖ, pᵢ) projects a 3d point Aₖ to the image plane of a camera with pose pᵢ.

FIG. 6 schematically illustrates elements for aggregating and encoding information to form the global BEVM 600 employing a deformable spatial cross attention (DSCA) routine 350. This includes the estimated 3D pose pᵢ of image Iᵢ for each item in the dataset D from the second image processing step 250 being subject to alignment and aggregation with the geo-hashed BEVM 400, and encoded to generate the up-to-date geo-hashed BEVM 600 employing the DSCA routine 350, which has a DSCA layer 355. This includes using an original tile portion 400-1, subjecting the original tile portion 400-1 to the DSCA routine 350 and the encoding routine 330 to form an updated tile portion 400-2. The updated tile portion 400-2 is captured in the global BEVM 600, which is geo-hashed.

The DSCA routine 350 executes in accordance with the following relationship:
cₖ: position of the k-cell in BEV tile prior;
Tₚ_{ₙ}(cₖ): project the 3-d cₖ to the image with calibration parameters pₙ; and
Δ(kᵤ_{ₙₖ}, q_{c}_{ₖ}): the MLP that maps the concatenated the 2D feature at uₙₖ and the BEV feature at cₖ to an offset: u′ₙₖₘ=uₙₖ+Δₘ(kᵤ_{ₙₖ}, q_{c}_{ₖ}), m=1, . . . , #deformable points, where kᵤ_{ₙₖ}=F(uₙₖ), q_{c}_{ₖ}=BEV(cₖ). This is illustrated as the

The DSCA layer 355 includes as follows:

$$DSCA ( {q}_{{c}_{k}} , F , BEV , {p}_{n} ) = {softmax}_{m} [ {W}_{q} {{q}_{c} ( {W}_{k} {k}_{u} )}^{T} {W}_{v} {k}_{u} / d ]$$

where q_{c}=BEV(cₖ), kᵤ=F(u′ₙₖₘ), d the dim of the embedding

In this manner, the DSCA routine 350 generates an updated BEV tile 400-2 from the original BEV tile 400-1. The global BEVM 600 has the updated tile portion 400-2 incorporated therein.

The encoding routine 330 may employ a Swin Transformer transform the original tile portion 400-1 to the updated tile portion 400-2.

FIG. 7 schematically illustrates elements for decoding the up-to-date BEVM 600, thus enabling it to be useable as an element of an on-vehicle or off-vehicle navigation system. The updated tile portion 400-2, which is encoded into the customized BEVM 600, along with a corresponding GNSS location(s) 55, can be subjected to a Swin transformer 156 and a multi-layer perception neural network (MLP) 157 to determine a polyline and associated probability {(Li, pᵢ)} 158. An example polyline and associated probability {(Li, pᵢ)} 158 is pictorially shown for purposes of illustrating the concept.

A Swin Transformer is a type of vision transformer architecture designed for computer vision tasks, which utilizes a shifted window mechanism to efficiently capture both local and global information within an image, creating a hierarchical feature representation by progressively merging image patches across different scales while maintaining low computational complexity. It divides an image into local windows for attention calculations, then shifts these windows into subsequent layers to enable communication between neighboring regions, making it suitable for tasks like image classification, object detection, and semantic segmentation.

The polyline L_i={(x_k,y_k;s_k)} includes a sequence of 2D points with score s_k, the validity score of the point (x_k,y_k), with p_i being the likeliness of L_i holding a valid polyline. A loss function includes the loss associated with each matched pair, e.g., enclosed area formed by polylines. A loss between two polylines: {v₁, v₂, . . . , v_{N}} and {u₁, u₂, . . . , u_{M}} are defined as the enclosed area of the polygon {v₁, v₂) . . . , v_{N}, u_{M}, . . . , u₂, u₁, v₁}, wherein U is ground truth, and V-Li, Pi, estimation of MLP 157. The goal of the Swin Transformer 156 and MLP 157 is to minimize the enclosed area of the polygons depicted in the polyline 158 for the updated tile portion 400-2 of the updated BEVM 600.

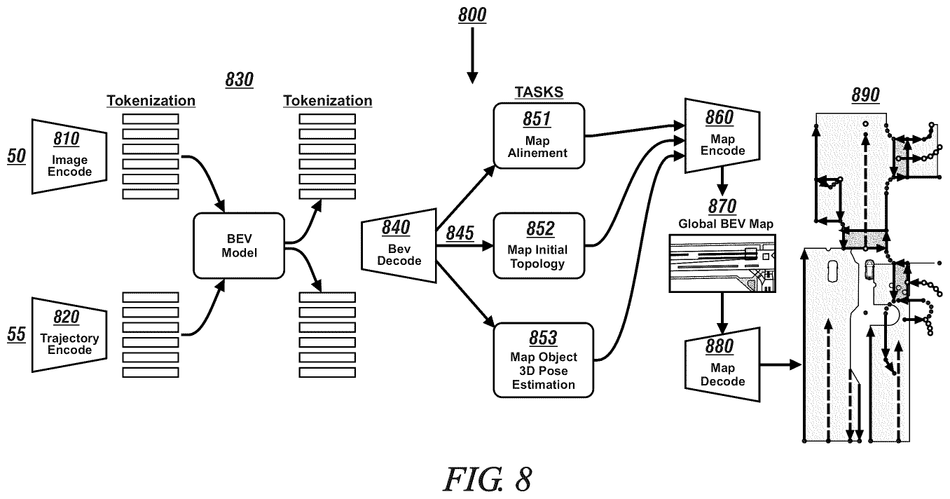

FIG. 8 schematically illustrates details related to another embodiment of the map construction routine 800 to generate an electronic representation of the up-to-date geo-hashed BEVM 600, which involves crowd-sensing alignment, generative AI, and explicit 3D point cloud modeling, without a need for OSM bootstrapping.

Overall, the map construction routine 800 includes taking input of raw images and GPS poses from each vehicle, with sparseness and compressed information being in a BEV representation. The cameras from the plurality of vehicles 10 generate a plurality of images 50 and corresponding GNSS locations 55, which are continuously, periodically, regularly and/or sporadically input to an image encoder 810 and a trajectory encoder 820, respectively. The resultant encoded images and encoded trajectories are supplied as input to a generative artificial intelligence (GenAI) system 830. The Gen AI system 830 operates in a virtual space, using an implicit learning-based approach and transformers to generate content in the form of a tokenized datastream 845 that can be employed in forming a crowd-sourced global BEV map.

The tokenized datastream 845 is input to a map alignment task 851, a map topology task 852, and an object 3D pose estimation task 853, the results of which are input to a map encoding routine 860, from which a global BEVM 870 is generated and stored in the cloud environment for future reference. The global BEVM 870 can be subsequently downloaded and subjected to a decode routine 880 to generate a viewable map 890 on-vehicle.

The raw images and GPS poses are captured from a plurality of vehicles to build crowd-sourced global BEV maps, without explicit modeling, aggregation, or alignment using a full-learning based GenAI system with transformer architecture and implicit learning.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by special-purpose hardware-based systems that perform the specified functions or acts, or combinations of special-purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A system for generating a digital street map that is representative of a geographical area, the system comprising:
a controller, the controller in communication with a plurality of vehicles having digital cameras and Global Navigation Satellite System (GNSS) sensors;
the controller in communication with a memory device containing executable code, the executable code including a bird's eye view (BEV) mapping routine, the BEV mapping routine including the following steps:
capture, for a geographical area, a plurality of images and a plurality of corresponding locations via the plurality of vehicles having digital cameras and GNSS sensors;
extract a plurality of anchor points from the plurality of images;
estimate a pose of each of the plurality of images based upon the plurality of anchor points from the plurality of images;
aggregate and encode the pose of each of the plurality of images into an electronic map to generate a customized BEV map (BEVM) portion for the geographical area; and
capture the customized BEVM portion in the memory device.

2. The system of claim 1, wherein the BEV mapping routine further comprises the following actions:
access, via one of the plurality of vehicles, the customized BEVM portion from the memory device; and
decode the customized BEVM portion to extract features for the geographical area.

3. The system of claim 2, wherein the one of the plurality of vehicles includes a navigation system and an advanced driver assistance system (ADAS); and
wherein the one of the plurality of vehicles operates the ADAS system based upon the features for the geographical area.

4. The system of claim 1, wherein the BEV mapping routine further comprises the following actions:
communicate the customized BEVM portion to one of the plurality of vehicles to effect operational control thereof.

5. The system of claim 1, further comprising executing a neural network to aggregate and encode the pose of each of the plurality of images into the electronic map to generate the customized BEVM portion for the geographical area.

6. The system of claim 1, wherein the plurality of vehicles having digital cameras and GNSS sensors are geo-fenced based upon proximity to the geographical area.

7. The system of claim 1, wherein the electronic map is based upon an open street map.

8. The system of claim 1, wherein the pose of each of the plurality of images comprises a three-dimensional (3D) pose.

9. The system of claim 1, wherein the plurality of images that are captured comprise 2D images that are forward of the vehicle.

10. The system of claim 1, wherein the memory device is cloud-based.

11. A method for generating a digital street map that is representative of a geographical area, the method comprising:
capturing, via a controller, a plurality of images and a plurality of corresponding locations for a geographical area via a plurality of vehicles having digital cameras and Global Navigation Satellite System (GNSS) sensors in a memory device;
extracting a plurality of anchor points from the plurality of images;
estimating a pose of each of the plurality of images based upon the plurality of anchor points from the plurality of images;
aggregating and encoding, via a bird's eye view (BEV) mapping routine, the pose of each of the plurality of images into an electronic map;
generating a customized BEV map (BEVM) portion for the geographical area based upon the electronic map; and
storing the customized BEVM portion in the memory device.

12. The method of claim 11, further comprising:
accessing, via one of the plurality of vehicles, the customized BEVM portion from the memory device; and
decoding the customized BEVM portion to extract features for the geographical area.

13. The method of claim 12, wherein the one of the plurality of vehicles includes a navigation system and an advanced driver assistance system (ADAS); the method further comprising:
operating the ADAS of the one of the plurality of vehicles based upon the features for the geographical area.

14. The method of claim 11, further comprising:
communicating the customized BEVM portion to one of the plurality of vehicles to effect operational control thereof.

15. The method of claim 11, further comprising executing a neural network to aggregate and encode the pose of each of the plurality of images into the electronic map to generate the customized BEVM portion for the geographical area.

16. The method of claim 11, further comprising geo-fencing the plurality of vehicles having digital cameras and GNSS sensors based upon a proximity to the geographical area.

17. The method of claim 11, further comprising integrating the electronic map into an open street map.

18. The method of claim 11, further comprising storing the customized BEVM portion in a cloud-based memory device.

19. A system for generating a digital street map that is representative of a geographical area, the system comprising:
a controller, the controller in communication with a plurality of vehicles having digital cameras and Global Navigation Satellite System (GNSS) sensors;
the controller in communication with a cloud-based memory device containing executable code, the executable code including a bird's eye view (BEV) mapping routine, the BEV mapping routine including the following actions:
capture, for a geographical area, a plurality of images and a plurality of corresponding locations via the plurality of vehicles having digital cameras and GNSS sensors;
extract a plurality of anchor points from the plurality of images;
estimate a pose of each of the plurality of images based upon the plurality of anchor points from the plurality of images;
aggregate and encode the pose of each of the plurality of images into an electronic map;
generate a customized BEV map (BEVM) portion for the geographical area based upon the electronic map; and
store the customized BEVM portion for the geographical area in the cloud-based memory device.

20. The system of claim 19, wherein the BEV mapping routine further comprises the following actions:
access, via one of the plurality of vehicles, the customized BEVM portion from the memory device; and
decode the customized BEVM portion to extract features for the geographical area.
